(19) United States
(12) Patent Application Publication
(10) Pub. No.: US 2006/0068986 A1
(43) Pub. Date: Mar. 30, 2006

(54) Catalyst elements and methods of making and using

(76) Inventor: Felice DiMascio, Rocky Hill, CT (US)

Correspondence Address: CANTOR COLBURN, LLP, 55 GRIFFIN ROAD SOUTH, BLOOMFIELD, CT, 06002, US

(21) Appl. No.: 11/235,848

(22) Filed: Sep. 27, 2005

Related U.S. Application Data
(60) Provisional application No. 60/613,541, filed on Sep. 27, 2004.

(51) Int. Cl. B01J 31/00

(52) U.S. Cl. 502/159; 502/325

(57) ABSTRACT

A catalyst element includes a rigid body comprising a plurality of tortuous flow paths, wherein the rigid body comprises a plurality of catalyst particles and a binder, wherein each one of the plurality of catalyst particles comprises a reactive species disposed onto a surface of a support. The catalyst element may be useful as a catalyst in a variety of chemical processes including hydrogenation, dehydrogenation, hydrogenolysis, oxidation, reduction, alkylation, dealkylation, carbonylation, decarbonylation, coupling, isomerization, amination, deamination, or hydrodehalogenation.

### CROSS REFERENCE TO RELATED APPLICATIONS

This application claims the benefit of U.S. Provisional Patent Application Ser. No. 60/613,541, filed Sep. 27, 2004, which is incorporated herein by reference in its entirety.

### BACKGROUND

This disclosure generally relates to catalyst elements, wherein the element includes a heterogeneous catalyst.

Catalysts, which may generally take the form of heterogeneous, homogeneous, or biological catalysts, are of significant importance to the chemical industry as evidenced by the fact that the great majority of all chemicals produced have been in contact with a catalyst at some point during their production. Despite the many advances in the areas of homogeneous and biological catalysis, heterogeneous catalysts remain the predominant form used by industry. Heterogeneous catalysts are favored in part because they tolerate a much wider range of reaction temperatures and pressures, they can be more easily and inexpensively separated from a reaction mixture by filtration or centrifugation, they can be regenerated, and they are less toxic than their homogeneous or biological counterparts.

A heterogeneous catalyst is generally a solid material that operates on reactions taking place in the gaseous or liquid state, and generally includes a reactive species and a support for the reactive species, which optionally may be porous. One problem associated with heterogeneous catalysts is desorption of the reactive species from the support. When the number of the catalyst's reactive species decreases, the catalyst is not as effective and the reaction rate and/or product selectivity is reduced. Another disadvantageous feature of heterogeneous catalysts is catalyst attrition through the release of catalyst fines, which are small particles of spent catalyst that can remain in the reaction mixture and/or pass into the products. The generation of catalyst fines can also have a deleterious effect on catalyst performance. Furthermore, removal of catalyst fines can become an expensive and/or time-consuming step during the production process. Yet another disadvantage of heterogeneous catalysts is bypassing or channeling of the catalyst by the reactant mixture. When the reaction mixture bypasses the catalyst, the reaction may not proceed as efficiently, product yield may decrease, and product contamination may occur. Yet still another disadvantage associated with heterogeneous catalysts is pressure drop. If the reactant mixture cannot pass through a catalyst chamber properly a pressure drop may occur and a large amount of power, which may be in the form of additional applied pressure, will be required to push the reactant mixture through the chamber.

Despite their suitability for their intended purposes, there nonetheless remains a need in the art for new and improved devices for use as heterogeneous catalysts. It would be particularly advantageous if such catalyst devices could eliminate or result in decreased desorption of the reactive species from the support. It would further be advantageous if such catalyst devices eliminated or minimized release of catalyst fines, channeling or bypassing, and pressure drop.

### SUMMARY

Disclosed herein is a catalyst element, which comprises a rigid body comprising a plurality of tortuous flow paths, wherein the rigid body comprises a plurality of catalyst particles and a binder, wherein each one of the plurality of catalyst particles comprises a reactive species disposed onto a surface of a support.

A method for making a catalyst element comprises forming a catalyst particle by disposing a reactive species onto a surface of a support; mixing a plurality of the catalyst particles with a binder; and processing a mixture of the plurality of catalyst particles and the binder to form the catalyst element, wherein the catalyst element defines a rigid body comprising a plurality of tortuous flow paths.

A method for catalyzing a chemical process comprises flowing a reaction mixture through a catalyst element, wherein the catalyst element comprises a rigid body comprising a plurality of tortuous flow paths, wherein the rigid body comprises a plurality of catalyst particles and a binder, wherein each one of the plurality of catalyst particles comprises a reactive species disposed onto a surface of a support; and increasing a reaction rate for the reaction mixture to produce a product.

### BRIEF DESCRIPTION OF THE DRAWINGS

Referring now to the FIGURE, which is an exemplary embodiment, and wherein the like elements are numbered alike:

The FIGURE is a schematic representation of a cylindrical catalyst element.

### DETAILED DESCRIPTION

Disclosed herein are catalyst element devices and methods for making and using the catalyst elements. The catalyst element generally comprises a rigid body comprising a plurality of tortuous flow paths, wherein the rigid body comprises a plurality of catalyst particles and a binder, wherein each one of the plurality of catalyst particles comprises a reactive species and a support. Desirably, the reactive species is disposed onto a surface of the support through chemisorption or physisorption. The reactive species is desirably in fluid communication with the plurality of tortuous flow paths. Optionally, one or more of the plurality of catalyst particles may further comprise a promoter and/or an ion exchange material, which may or may not be in fluid communication with the plurality of tortuous flow paths. In contrast to the prior art, the present catalyst elements advantageously reduce desorption of reactive species from a support and effectively eliminate release of catalyst fines. Further, any bypassing or fluidizing of the catalyst by a reactive mixture is effectively eliminated and any pressure drop that may occur is reduced.

The term “catalyst” has its ordinary meaning as used herein, and generically describes a material which increases the rate of a chemical reaction but which is not consumed by the reaction. Further, a catalyst affects only the rate of the reaction; it changes neither the thermodynamics of the reaction nor the equilibrium composition. Further, as used herein to describe the catalyst elements or components of the catalyst elements, the term “catalyst” is intended to refer to heterogeneous catalysts, as opposed to homogeneous or biological catalysts. The term “reactive species” is used herein for convenience to refer generically to an active component of the catalyst during a chemical reaction process. The term “promoter” has its ordinary meaning as used herein and generally describes a material that is not catalytically active by itself but, when in the presence of the reactive species, enhances the performance of the reactive species. The term “support” has its ordinary meaning as used herein and generally describes an inactive component of the catalyst during the chemical reaction process. The terms “reaction mixture” or “reactant mixture” are used herein for convenience to refer generically to any reactants of a reaction that are brought into contact with a catalyst.

Also, as used herein, the terms “first,” “second,” and the like do not denote any order or importance, but rather are used to distinguish one element from another, and the terms “the”, “a”, and “an” do not denote a limitation of quantity, but rather denote the presence of at least one of the referenced item. Furthermore, all ranges disclosed herein are inclusive of the endpoints and independently combinable.

In one embodiment, the reactive species comprises a metal or metal oxide, comprising an element of Groups 3-10 and 14 of a Periodic Table of Elements. Preferably, the reactive species comprises a precious metal or precious metal oxide. Precious metals comprise the elements of Groups 8, 9, and 10 of the Periodic Table of Elements. In one exemplary embodiment, the reactive species is a platinum oxide.

In one embodiment, when the reactive species comprises a metal oxide, the metal of the metal oxide is desirably in its highest possible oxidation state. In another embodiment, for metals with multiple oxidation states, the metal of the metal oxide may be partially oxidized. For example, with platinum oxides, platinum may be in the 2⁺ and/or in the 4⁺ oxidation state.

In one embodiment, the reactive species is in the form of fine powder particles. In another embodiment, the reactive species is in the form of coarse powder particles. Alternatively, the reactive species may be a mixture of fine and coarse powder particles. An average particle size of the reactive species is less than or equal to about 420 micrometers (40 U.S. mesh). More preferably the average particle size of the reactive species is less than or equal to about 177 micrometers (80 U.S. mesh).

The support may be a dense or porous solid. If the support is porous, the surface onto which the reactive species is adsorbed may include any internal pore surface. The support may be spherical (i.e., spheres or microspheres) or non-spherical (i.e., granules, pellets, powders, monoliths, extrudates, or cylinders).

A suitable support material may exhibit a wide range of chemical and structural properties and comprises materials such as silica, alumina, oxides, mixed oxides, zeolites, carbonates, clays, ceramics, and carbons. Suitable oxides include for example oxides of titanium, aluminum, niobium, silicon, zinc, zirconium, cerium and the like. Examples of suitable mixed oxides include alumina-titania, alumina-zirconia, ceria-zirconia, ceria-alumina, silica-alumina, silica-titania, silica-zirconia, and the like. Suitable zeolites include any of the more than about 40 known members of the zeolite group of minerals and their synthetic variants, including for example Zeolites A, X, Y, USY, ZSM-5, and the like, in varying Si to Al ratios. Suitable carbonates include for example carbonates of calcium, barium, strontium, and the like. Examples of suitable clays include bentonite, smectite, montmorillonite, paligorskite, attapulgite, sepiolite, saponite, kaolinite, halloysite, hectorite, beidellite, stevensite, fire clay, ground shale, and the like. Examples of suitable ceramics include earthy or inorganic materials such as silicon nitride, boron carbide, silicon carbide, magnesium diboride, ferrite, steatite, yttrium barium copper oxide, anthracite, glauconite, faujasite, mordenite, clinoptilolite, and the like. Suitable carbons include for example carbon black, activated carbon, carbon fibrils, carbon hybrids, and the like.

An average particle size of the support is about 0.1 to 30.0 millimeters (mm). More preferably average particle size of the support is about 0.25 to 0.85 mm. An average pore volume of the support is about 0.001 to about 5.0 cubic centimeters per gram (cm³/g). More preferably, the average pore volume of the support is about 0.01 to about 1 cm³/g. An average surface area of the support is about 1 to about 10,000 meters squared per gram (m²/g). More preferably, the average surface area of the support is about 100 to about 1500 m²/g.

Of these supports, ceramics are preferred. In one embodiment, the support is formed from those ceramics described in U.S. Pat. Nos. 4,725,390 and/or 4,632,876, herein incorporated by reference in their entireties. Other preferred ceramics are those made essentially from nonmetallic minerals (such as mineral clays) by firing at an elevated temperature. More preferred are ceramic materials commercially available under the trade name MACROLITE® by the Kinetico Company. The MACROLITE® ceramic materials are spherically shaped and characterized by having a rough texture, high surface area, and level of moisture absorption of less than about 0.5%. The low level of moisture absorption allows for a reactive species or reactive species precursor to penetrate a minimal depth into the surface of the ceramic, thereby disposing the reactive species onto a surface of the support, an optimum location for subsequent contact with a reaction mixture. The surface area of the MACROLITE® ceramic materials is believed to be on about 103 m²/g.

Optionally, one or more of the plurality of catalyst particles comprises a promoter, wherein the promoter is a different material or composition than the reactive species. Suitable promoters include compositions comprising a Group 3-7 or 14 element or Rare Earth element of the Periodic Table of Elements, or a combination comprising at least one of the foregoing elements. Rare Earth elements include lanthanum, actinium, the Lanthanide series, and the Actinide series. Preferred promoters are Rare Earth oxides, including for example lanthanum, cerium, neodymium, and thorium oxides. In one embodiment, the promoter is in the form of fine powder particles. In another embodiment, the promoter is in the form of coarse powder particles. Alternatively, the promoter may be a mixture of fine and coarse powder particles. An average particle size of the promoter is less than or equal to about 420 micrometers (40 U.S. mesh). More preferably the average particle size of the promoter is less than or equal to about 177 micrometers (80 U.S. mesh). A molar ratio of the reactive species to the promoter is preferably about 0.3:1 to about 100:1. More preferably, the molar ratio of the reactive species to the promoter is about 10:1.

Optionally, one or more of the plurality of catalyst particles comprises an ion exchange material (i.e., a natural or synthetic material that can undergo an ion exchange reaction), wherein the ion exchange material is different from the support. Ion exchange materials include, for example, ion exchange coals, mineral ion exchangers, synthetic inorganic ion exchangers, organic ion exchangers or the like, or a combination comprising at least one of the foregoing ion exchange materials. Suitable ion exchange coals include, for example, coals comprising weak acid moieties, such as a carboxylic acid functional group. Suitable mineral ion exchangers include, for example, ferrous aluminosilicates with cation exchange properties, (e.g., analcite, chabazite, glauconites, harmotome, heulandile, natrolite; montmorillonite, beidellite, and the like) or aluminosilicates with anion exchange properties (e.g., apatite, hydroxyapatite, monotmorillonite, kaolinite, feldspars, sodalites, cancrinites, and the like). Examples of suitable synthetic inorganic ion exchangers include microcrystals embedded in a porous clay binder, such as prepared by combining oxides of Groups 4 of the Periodic Table with oxides of Groups 5 and/or 6 and embedding them in the clay binder. Suitable organic ion exchangers include polyelectrolytes such as phenols, styrenes, or acrylates with cation exchange moieties (e.g., sulfonic acid group, carboxylic acid group, or the like) or anion exchange moieties (e.g., trimethylammonium group, dimethylethanolammonium group, or the like).

An average particle size of the ion exchange material is 0.1 to 30.0 mm. More preferably average particle size of the support is about 0.25 to 0.85 mm. When the ion exchange material is an organic ion exchanger it further comprises a crosslinking agent, wherein the crosslinking agent is in an amount of about 4 to about 55% wt of the total ion exchange material used. In one embodiment, a copolymer of styrene and divinylbenzene (DVB), where DVB is known the crosslinking agent is used, and DVB comprises about 4 to about 55% wt of the copolymer.

The binder provides a means of attachment for any of the components of the catalyst element as well as a means of providing and maintaining a shape of the catalyst element. The binder may be any material that will agglomerate the components and is compatible with the reactive mixture. The binder material is also chosen such that the structural integrity of the catalyst element essentially remains constant under reaction conditions. Suitable binder materials include non-crosslinked and crosslinked thermoplastic polymers, with an average molecular weight of greater than about 10². When crosslinked thermoplastic polymers are used, an amount of crosslinking may be about 0.1 to about 90%. Preferred thermoplastic polymers include epoxies, perfluoropropylalkoxys, phenolics, polyacetals, polyacrylics, polyalkyls, polyamideimides, polyamides, polyanhydrides, polyaramides, polyarylates, polyarylsulfones, polybenzimidazoles, polybenzothiazinophenothiazines, polybenzothiazoles, polybenzoxazoles, polybutadienes, polycarbonates, polycarboranes, polychlorotrifluoroethylenes, polychlorotrifluoroethylenes, polydibenzofurans, polydioxoisoindolines, polyesters, polyether etherketones, polyether ketone ketones, polyetherimides, polyetherketones, polyethersulfones, polyethylene tetrafluoroethylenes, polyethyleneimines, polyethylenes, polyhexafluoropropylene-co-tetrafluoroethylenes, polyimides, polyisoprenes, polymethacrylonitriles, polymethyl methacrylates, polymethylacrylates, polyolefins, polyoxabicyclononanes, polyoxadiazoles, polyoxindoles, polyoxoisoindolines, polyperfluopromethylalkoxys, polyperfluoromethylalkoxys, polyphenylene sulfides, polyphosphazenes, polyphthalides, polypiperazines, polypiperidines, polypyrazinoquinoxalines, polypyrazoles, polypyridazines, polypyridines, polypyromellitimides, polyquinoxalines, polysilazanes, polysiloxanes, polystyrenes, polysulfides, polysulfonamides, polysulfonates, polysulfones, polytetrafluoroethylenes, polythioesters, polytriazines, polytriazoles, polyureas, polyurethanes, polyvinyl acetates, polyvinyl alcohols, polyvinyl esters, polyvinyl ethers, polyvinyl halides, polyvinyl ketones, polyvinyl nitriles, polyvinyl thioethers, polyvinylidene fluorides, polyvinylpyrrolidones, or the like, or a copolymer of at least two of the foregoing thermoplastic materials, or a combination comprising at least one of the foregoing thermoplastic materials.

Optionally, the catalyst element comprises a non-catalyst particle. The non-catalyst particle may comprise any aforedescribed material or a combination of the aforedescribed materials with the proviso that the non-catalyst particle is exclusive of the reactive species. In addition to any of the aforedescribed materials, the non-catalyst particle may also comprise a filler, adhesive, or the like, or a combination comprising at least one of the foregoing materials. In one embodiment, the non-catalyst particle is the support particle. In another embodiment, the non-catalyst is the promoter, which may or may not be disposed onto the surface of the support particle. In still another embodiment, the non-catalyst particle is the ion exchange material, which may or may not be disposed onto the surface of the support particle.

An average particle size of the non-catalyst particle is about 0.1 to 30.0 millimeters (mm). More preferably the average particle size of the non-catalyst particle is about 0.25 to 0.85 mm. In one embodiment, the non-catalyst particle has a surface area of about 1 to about 1,500 meters squared per gram (m²/g).

The reactive species, and/or the optional promoter, and/or the optional ion exchange material, may be disposed onto the surface of the support by any of a number of techniques including for example impregnation, co-precipitation, deposition-precipitation, ion-exchange, dipping, spraying, vacuum deposition, adhesion, chemical bonding, or the like, or a combination comprising at least one of the foregoing disposing techniques.

In one embodiment, prior to disposing the reactive species, and/or the optional promoter, and/or the optional ion exchange material, onto the surface of the support, at least one of the reactive species and/or at least one promoter, and/or at least one ion exchange material may be agglomerated to form a composite. The composite may be formed by adhering, chemical bonding, or the like, or a combination comprising at least one of the foregoing techniques. In one embodiment, the composite may be about 595 micrometers (U.S. mesh 30) to about 2.830 mm (U.S. mesh 7). Once the composite is formed, it may be disposed onto the surface of the support by any of the aforedescribed disposing techniques.

An average particle size of the catalyst particles (i.e., the reactive species, and/or the optional promoter, and/or the optional ion exchange material, disposed onto the surface of the support) is about 0.75 to about 60 mm. More preferably the average particle size of the catalyst particles is about 0.75 to about 4 mm.

Once formed, the plurality of catalyst particles, and/or the optional non-catalyst particle, are mixed with the binder to form a homogeneous or substantially homogeneous mixture. Alternatively, the plurality of catalyst particles, and/or the optional non-catalyst particle, may first be ground into fine particles and then mixed with the binder to form a homogeneous or substantially homogeneous mixture. The mixture of the plurality of catalyst particles, and/or the optional non-catalyst particle, and binder may then be heat and pressure treated, such as with an extruder, compression molder, injection molder, or the like, or a combination comprising at least one of the foregoing, to produce the catalyst element. Depending on the type heat and pressure treatment, a lubricant may be used as an additive to facilitate formation of the catalyst element. The lubricant is selected such that catalyst element properties are essentially not affected and such that a minimum or none of the tortuous paths are blocked.

The reactive species of each of the plurality of catalyst particles may be activated before or after formation of the mixture or before or after formation of the catalyst element. The reactive species may be activated from about 100 to about 850 degrees Celsius (° C.). Activation of the reactive species may take from about 10 to about 240 minutes. Activation of the reactive species may be carried out, for example, in the presence of air, oxygen, water, hydrogen, or the like, or a combination comprising at least one of the foregoing.

The composition and amount of each component of the catalyst element is selected to provide effective catalytic activity and selectivity for the chemical process to be catalyzed. In one embodiment, the catalyst element comprises about 0.01 to about 30 weight percent (wt %) reactive species, about 40 to about 99 wt % support, and about 0.01 to about 25 wt % binder, based on the total weight of the catalyst element. Desirably, the catalyst element comprises less than or equal to about 15 wt % reactive species, about 50 to about 70 wt % support, and less than or equal to about 15 wt % binder. The catalyst element may further comprise about 0.01 to about 5 wt % of the optional promoter, and/or about 0.01 to about 5 wt % of the optional ion exchange material, and/or about 0.01 to about 50 % of the optional non-catalyst particle.

The catalyst element, formed from the aforedescribed materials, may be of any shape or size effective for use in a reaction process. For example, the catalyst element may be cylindrical, rod-shaped, conical, frustoconical, disc-shaped, granular, pellet-shaped, spherical, or the like.

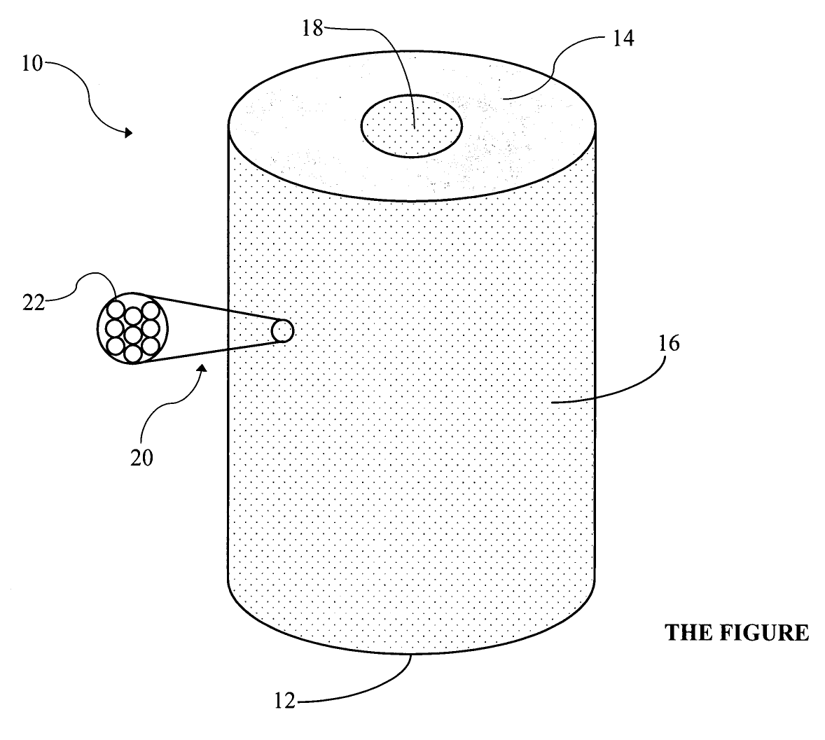

In one exemplary embodiment, shown as FIG. 1, catalyst element 10 is cylindrical. Catalyst element 10 is preferably capped at one open end 12, while the other open end 14 is left uncapped. In one embodiment, catalyst element 10 is capped with a plugging material (not shown) or may be pre-capped during fabrication. With cylindrical catalyst element 10, the reaction mixture may flow through the tortuous paths 22 (as shown in inset 20) in a radial direction from outside to inside allowing the entire exterior surface 16 of catalyst element 10 to contact the reaction mixture. Uncapped end 14 may provide an outlet for a catalyzed reaction mixture. Alternatively, the reaction mixture may flow through the tortuous paths 22 (as shown in inset 20) from inside to outside, allowing the entire interior surface 18 of catalyst element 10 to contact the reaction mixture. In this embodiment, uncapped end 14 provides an inlet for the reaction mixture. Dimensions such as length, inner diameter and outer diameter may readily be tailored toward the particular application. In one embodiment, the cylindrical catalyst element 10 has a length of about 10 to about 75 centimeters (cm), an inner diameter of about 0.5 to about 20 cm, and an outer diameter of about 1 to about 25 cm.

Although the tortuous paths 22 are shown as spheres, they may be any shape as determined by particle-particle interstices created within the catalyst element during its fabrication.

It should be recognized by those skilled in the art that the catalyst elements described herein may advantageously also function as filtering devices. In one embodiment, the catalyst element filters all or substantially all particulates of about 0.5 to about 100 micrometers. In another embodiment, the catalyst element filters all or substantially all particulates less than about 10 micrometers.

Furthermore, it should be recognized by one of ordinary skill in the art that the rigidity and structural integrity provided by the binder material results in reduced desorption of the at least one reactive species from the support and also effectively eliminates the release of catalyst fines. Because the entire surface of the catalyst element contacts the reaction mixture bypassing or fluidizing of the tortuous paths of the catalyst element by the reactive mixture is effectively eliminated and any pressure drop that may occur is reduced.

The catalyst elements described herein are further advantageous in that they may be used in numerous chemical reaction processes, including among others hydrogenation, dehydrogenation, hydrogenolysis, oxidation, reduction, alkylation, dealkylation, carbonylation, decarbonylation, coupling, isomerization, amination, deamination, hydrodehalogenation, or the like.

A preferred process of use is the oxidative production of a halogen oxide from an alkali metal halite solution. One such process generally comprises employing a cation exchange column for producing an aqueous effluent containing halous acid from the alkali metal halite solution, which is then fed to a catalytic reactor containing the catalyst element for converting the halous acid to halogen oxide. A second such process generally comprises employing an electrochemical acidification cell for producing an aqueous effluent containing a halous acid from the alkali metal halite solution, which is then fed to a catalytic reactor containing the catalyst element for converting the halous acid to halogen oxide. A third such process generally comprises mixing an alkali metal halite solution and a mineral acid, which is then fed to a catalytic reactor containing the catalyst element for converting the halous acid to halogen oxide. In one exemplary embodiment, the catalyst element may be used in the production of chlorine dioxide from an alkali metal chlorite solution.

This disclosure is further illustrated by the following non-limiting examples.

In these examples, which are directed towards the production of chlorine dioxide using the catalyst elements disclosed herein, the following parameters were recorded: chlorine dioxide flow rate, concentration, pH, and temperature as well as sodium chlorite and mineral acid flow rates.

A properly calibrated Direct Reading Spectrophotometer, Model No. DR/2010, was used to measure the chlorine dioxide concentration (mg/L) in the catalytic reactor effluent solution using Hach Company Method 8138. Measurement of the yield provided a standard for evaluating actual performance of the process/system and was determined in accordance with the following mathematical relationship:

$$\% \text{Yield} = \frac{\text{actual}}{\text{theoretical}} \times 100$$

wherein the actual yield was obtained from the amount of chlorine dioxide generated, and wherein the theoretical yield was calculated by the amount of chlorine dioxide that could be generated from the concentration of the sodium chlorite in the starting solution. Since five moles of chlorite ions are required to produce 4 moles of chlorine dioxide, based on the following chemical reaction:
5NaClO₂+4HCl→4ClO₂+5NaCl+2H₂O
the theoretical yield was calculated using the following mathematical relationship:

$$\% TheoreticalYield = \frac{{[ {ClO}_{2} ]}_{product}}{{[ \frac{4}{5} ] [ {NaClO}_{2} ]}_{feed}} \times 100$$

### EXAMPLE 1

In this example, the reactive species was platinum oxide and the support was coconut shell carbon black having a particle size between 74 micrometers (200 U.S. mesh) and 274 micrometers (50 U.S. mesh) that was purified and backwashed to be free of fines. To place the platinum oxide on the surface of the support, a precursor solution was made by dissolving 9.0 grams of tetraamineplatinum (II) chloride crystals in 8.3 milliliter (mL) of 30% ammonia hydroxide and 393 mL of 25% isopropyl alcohol at 35° C., such that the solution contained 5.0 grams of platinum. The precursor solution was then sprayed in a fine mist onto the surface of 1000 cubic centimeters (cm³) of the carbon support so as to form an even coating on the surface of the support. The coated carbon was dried, placed in a ceramic crucible, and calcined in an oxygen-containing environment at 300° C., for 5 hours. The quantity of platinum on the support was about 0.5% by weight, based on the total weight of the catalyst particles.

The catalyst particles, comprising the platinum oxide supported on the coconut shell carbon black, were processed into a 2.5-inch diameter by 10-inch height block using a polyethylene powder binder (Omnipure Filter Company) having a particle size from about 10 micrometers to about 50 micrometers. The final catalyst element had about 78 wt % of catalyst particles and 22 wt % binder.

The catalyst element was installed in a 10-inch long polypropylene vessel. The flow rate through the catalyst element-filled housing was controlled by a needle valve. Two peristaltic pumps were used to independently inject a 25% sodium chlorite (NaClO₂) and a 32% hydrochloric acid (HCl) solution into the vessel upstream of the catalyst element. The catalyst element was operated for eight hours, the results of which are shown in Table 1.

TABLE 1

| | |
|---|---|
| ClO₂ Flow Rate (mL/min) | 162 |
| NaClO₂ Flow Rate (mL/min) | 0.59 |
| HCl Flow Rate (mL/min) | 0.56 |
| ClO₂ Concentration (ppm) | 460 |
| ClO₂ pH | 1.68 |
| ClO₂ Temperature (° C.) | 22.3 |
| % Yield | 70.1 |

### EXAMPLE 2

Similar to Example 1, the reactive species was platinum oxide and the support was coconut shell carbon black having a particle size between 74 micrometers (200 U.S. mesh) and 274 micrometers (50 U.S. mesh) that was purified and backwashed to be free of fines. In this example, 5.0 grams of platinum (IV) oxide (Alfa Aesar, Item No. 40402) was disposed on 1429 grams of the powdered carbon black support and thoroughly mixed. The quantity of platinum on the support was about 0.5% by weight, based on the total weight of the catalyst particles.

The catalyst particles, comprising the platinum oxide supported on the coconut shell carbon black, were similarly processed into a 2.5-inch diameter by 10-inch height block using a polyethylene powder binder (Omnipure Filter Company) having a particle size from about 10 micrometers to about 50 micrometers. The final catalyst element had about 78 wt % of catalyst particles and 22 wt % binder.

The catalyst element was installed in a 10-inch long polypropylene vessel. The flow rate through the catalyst element-filled housing was controlled by a needle valve. Two peristaltic pumps were used to independently inject a 25% sodium chlorite (NaClO₂) and a 32% hydrochloric acid (HCl) solution into the vessel upstream of the catalyst element. Table 2 displays the results after 20 hours of operation.

TABLE 2

| | |
|---|---|
| ClO₂ Flow Rate (mL/min) | 152 |
| NaClO₂ Flow Rate (mL/min) | 0.59 |
| HCl Flow Rate (mL/min) | 0.56 |
| ClO₂ Concentration (ppm) | 425 |
| ClO₂ pH | 1.72 |
| ClO₂ Temperature (° C.) | 20.8 |
| % Yield | 60.7 |

### EXAMPLE 3

In this example, the reactive species was platinum oxide and the support was carbon, in coal form, having a particle size between 74 micrometers (200 U.S. mesh) and 274 micrometers (50 U.S. mesh) that was purified and backwashed to be free of fines. Similar to Example 2, 5.0 grams of platinum (IV) oxide (Alfa Aesar, Item No. 40402) was disposed on 1429 grams of the powdered carbon support and thoroughly mixed. The quantity of platinum on the support was about 0.35% by weight, based on the total weight of the catalyst particles.

The catalyst particles, comprising the platinum oxide supported on the coal carbon, were similarly processed into a 2.5-inch diameter by 10-inch height block using a polyethylene powder binder (Omnipure Filter Company) having a particle size from about 10 micrometers to about 50 micrometers. The final catalyst element had about 78 wt % of catalyst particles and 22 wt % binder.

The catalyst element was installed in a 10-inch long polypropylene vessel. The flow rate through the catalyst element-filled housing was controlled by a needle valve. Two peristaltic pumps were used to independently inject a 25% sodium chlorite (NaClO₂) and a 32% hydrochloric acid (HCl) solution into the vessel upstream of the catalyst element. Table 3 displays the results after 41 hours of operation.

TABLE 3

| | |
|---|---|
| ClO₂ Flow Rate (mL/min) | 153 |
| NaClO₂ Flow Rate (mL/min) | 0.59 |
| HCl Flow Rate (mL/min) | 0.56 |
| ClO₂ Concentration (ppm) | 403 |
| ClO₂ pH | 1.89 |
| ClO₂ Temperature (° C.) | 21.1 |
| % Yield | 57.9 |

In comparing the results from Examples 2 and 3, the catalyst element making use of the coconut shell carbon support had a greater % yield than the catalyst element using coal carbon. One difference between the two types of catalyst elements was the level of platinum oxide loading. This may be a result of the porosity of the support particles. The coconut shell carbon has a predominantly microporous (pore size less than about 20 Angstroms) structure, while the coal carbon has balanced proportion of microporous, mesoporous (pore size greater than about 20 Angstroms and less than about 500 Angstroms), and macroporous (pore size greater than about 500 Angstroms) particles. The increased yield may be attributed to the greater amount of reactive species that may have been supported on an external surface of the coconut shell carbon and thus available to the reactant mixture compared to a greater amount of reactive species that may have been supported inside the pore structure of the coal support and thus less available to the reactant mixture.

### EXAMPLE 4

Similar to Example 1, the reactive species was platinum oxide and the support was coconut shell carbon black having a particle size between 74 micrometers (200 U.S. mesh) and 274 micrometers (50 U.S. mesh) that was purified and backwashed to be free of fines. In this example, 5.0 grams of platinum (IV) oxide (Alfa Aesar, Item No. 40402) was disposed on 1429 grams of the powdered carbon black support and thoroughly mixed. The quantity of platinum on the support was about 0.35% by weight, based on the total weight of the catalyst particles.

The catalyst particles, comprising the platinum oxide supported on the coal carbon, were similarly processed into a 2.5-inch diameter by 10-inch height block using a polyethylene powder binder (Omnipure Filter Company) having a particle size from about 5 micrometers to about 25 micrometers. The final catalyst element had about 81 wt % of catalyst particles and 19 wt % binder.

The catalyst element was installed in a 10-inch long polypropylene vessel. The flow rate through the catalyst element-filled housing was controlled by a needle valve. Two peristaltic pumps were used to independently inject a 25% sodium chlorite (NaClO₂) and a 32% hydrochloric acid (HCl) solution into the vessel upstream of the catalyst element. Table 4 displays the results after 53 hours of operation.

TABLE 4

| | |
|---|---|
| ClO₂ Flow Rate (mL/min) | 176 |
| NaClO₂ Flow Rate (mL/min) | 0.59 |
| HCl Flow Rate (mL/min) | 0.56 |
| ClO₂ Concentration (ppm) | 474 |
| ClO₂ pH | 1.98 |
| ClO₂ Temperature (° C.) | 18.3 |
| % Yield | 78.4 |

In comparing the results from Examples 2 and 4, the catalyst element making use of the smaller particle size binder had a greater % yield than the catalyst element using a larger particle size binder. The smaller particle size allowed for slightly less binder to be used while still achieving a rigid structure. A reduced amount of binder may be responsible for the increased yield because there would have been more surface area or contact area (i.e., more catalytic sites) available for catalyzing the reaction than if a greater amount of binder were used.

### EXAMPLE 5

The catalyst element was process in an identical manner as in Examle 4. However, in this example, instead of using a 32% HCl solution, a mixture containing a 24% solution of sulfuric acid (H₂SO₄) and a 9% solution of phosphoric acid (H₃PO₄) was used. Table 5 displays the results after 53 hours of operation.

TABLE 5

| | |
|---|---|
| ClO₂ Flow Rate (mL/min) | 159 |
| NaClO₂ Flow Rate (mL/min) | 0.59 |
| HCl Flow Rate (mL/min) | 0.56 |
| ClO₂ Concentration (ppm) | 568 |
| ClO₂ pH | 2.31 |
| ClO₂ Temperature (° C.) | 17.4 |
| % Yield | 84.9 |

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A catalyst element comprising:
a rigid body comprising a plurality of tortuous flow paths, wherein the rigid body comprises a plurality of catalyst particles and a binder, wherein each one of the plurality of catalyst particles comprises a reactive species disposed onto a surface of a support.

2. The catalyst element of claim 1, wherein the reactive species is in fluid communication with the plurality of tortuous flow paths.

3. The catalyst element of claim 1, wherein the reactive species comprises a metal or metal oxide comprising an element of Groups 3-10 and 14 of a Periodic Table of Elements.

4. The catalyst element of claim 3, wherein the reactive species comprises a precious metal.

5. The catalyst element of claim 4, wherein the reactive species further comprises a non-precious metal.

6. The catalyst element of claim 5, wherein a molar ratio of the precious metal to the non-precious metal is about 0.3:1 to about 100:1.

7. The catalyst element of claim 1, wherein one or more of the plurality of catalyst particles further comprises a promoter, wherein the promoter is a different material or composition than the reactive species.

8. The catalyst element of claim 7, wherein the promoter is in fluid communication with the plurality of tortuous flow paths.

9. The catalyst element of claim 7, wherein the promoter comprises a composition comprising a Group 3-7 or 14 element, a Rare Earth element, or a combination comprising at least one of the foregoing elements of the Periodic Table of Elements.

10. The catalyst element of claim 1, wherein one or more of the plurality of catalyst particles further comprises an ion exchange material, wherein the ion exchange material is different from the support.

11. The catalyst element of claim 10, wherein the ion exchange material is in fluid communication with the plurality of tortuous flow paths.

12. The catalyst element of claim 1, further comprising a non-catalyst particle.

13. The catalyst element of claim 1, wherein the binder comprises a non-crosslinked thermoplastic polymer, crosslinked thermoplastic polymer, or a combination comprising at least one of the foregoing binder materials.

14. The catalyst element of claim 1, wherein the reactive species is in an amount of about 0.01 to about 30 weight percent (wt %), wherein the support is in an amount of about 40 to about 99 wt %, wherein the binder is in an amount of about 0.01 to about 25 wt % binder, wherein the weight percent is based on the total weight of the catalyst element.

15. The catalyst element of claim 1, wherein the non-catalyst particle is in an amount of about 0.01 to about 50 wt %.

16. The catalyst element of claim 1, wherein the promoter is in an amount of about 0.01 to about 5 wt %.

17. The catalyst element of claim 1, wherein the ion exchange material is in an amount of about 0.01 to about 5 wt %.

18. A method for making a catalyst element comprising:
forming a catalyst particle by disposing a reactive species onto a surface of a support;
mixing a plurality of catalyst particles with a binder; and
processing a mixture of the plurality of catalyst particles and the binder to form the catalyst element, wherein the catalyst element defines a rigid body comprising a plurality of tortuous flow paths.

19. The method of claim 18, wherein the reactive species is in fluid communication with the plurality of tortuous flow paths.

20. The method of claim 18, wherein one or more catalyst particles further comprises a promoter.

21. The method of claim 20, wherein the promoter is in fluid communication with the plurality of tortuous flow paths.

22. The method of claim 18, wherein one or more catalyst particles further comprises an ion exchange material.

23. The method of claim 22, wherein the ion exchange material is in fluid communication with the plurality of tortuous flow paths.

24. The method of claim 18, wherein the mixture further comprises a non-catalyst particle.

25. The method of claim 18, further comprising grinding the plurality of catalyst particles into fine powdered particles.

26. The method of claim 18, further comprising activating the reactive species.

27. The method of claim 18, wherein the processing comprises heat and pressure treating.

28. A method for catalyzing a chemical process, comprising:
flowing a reaction mixture through a catalyst element, wherein the catalyst element comprises a rigid body comprising a plurality of tortuous flow paths, wherein the rigid body comprises a plurality of catalyst particles and a binder, wherein each one of the plurality of catalyst particles comprises a reactive species disposed onto a surface of a support; and
increasing a reaction rate for the reaction mixture to produce a product.

29. The method of claim 28, wherein the chemical process comprises hydrogenation, dehydrogenation, hydrogenolysis, oxidation, reduction, alkylation, dealkylation, carbonylation, decarbonylation, coupling, isomerization, amination, deamination, or hydrodehalogenation.

30. The method of claim 28, wherein the chemical process comprises oxidative production of a halogen oxide from an alkali metal halite solution.
